(19) United States
(12) Patent Application Publication
(10) Pub. No.: US 2016/0011770 A1
(43) Pub. Date: Jan. 14, 2016

(54) DOCUMENT AUTOGRAPH SYSTEM AND METHOD

(71) Applicant: GLOSE SAS, Paris (FR)

(72) Inventors: Nicolas Princen, Neuilly sur Seine (FR); Julien Chaumond, Paris (FR); Thomas Ricouard, Paris (FR)

(21) Appl. No.: 14/794,613

(22) Filed: Jul. 8, 2015

Related U.S. Application Data
(60) Provisional application No. 62/021,922, filed on Jul. 8, 2014.

(51) Int. Cl. G06F 3/0488; G06F 3/0354; G06F 3/041

(52) U.S. Cl. CPC G06F 3/04883; G06F 3/041; G06F 3/03545

(57) ABSTRACT

A system and method for generating an electronic document autograph is disclosed. One embodiment includes presenting an author-autograph interface including a media frame, a text frame and a signature frame. The method can also include generating an autograph based on media presented in these frames.

### CROSS-REFERENCE TO RELATED APPLICATIONS

This application is a non-provisional from, and claims the benefit of U.S. Provisional Application No. 62/021,922 filed Jul. 8, 2014, which application is hereby incorporated herein by reference in its entirety for all purposes.

### BACKGROUND

Electronic books (e-books) are a rapidly growing media. In the United States, it has already grown to a market share of 30% of total book sales. The e-book market first developed on devices that were specifically designed for reading, equipped with an epaper-like screen. Since the democratization of this market, e-book consumers have started leaving behind those simple, specialized devices and moving towards more versatile, multipurpose multimedia and personal computing devices like tablets, personal computers, and mobile phones. However, the existing e-book reading applications have yet to exploit all the opportunities to interact with texts provided by modern computing devices. In particular, the age-old practice of authors autographing books has little digital counterpart.

In view of the foregoing, a need exists for improved document autograph systems and methods, including autographs for e-books, in an effort to overcome the aforementioned obstacles and deficiencies of conventional systems.

### BRIEF DESCRIPTION OF THE DRAWINGS

FIG. 1 is an exemplary network diagram illustrating an embodiment of a document autograph system.

FIG. 2 is an exemplary drawing illustrating an embodiment of a blank author-autograph interface.

FIG. 3 depicts the author autograph interface of FIG. 2 that includes an author-autograph.

FIG. 4 is an exemplary data flow diagram illustrating data flow that facilitates a document autograph, in accordance with an embodiment.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

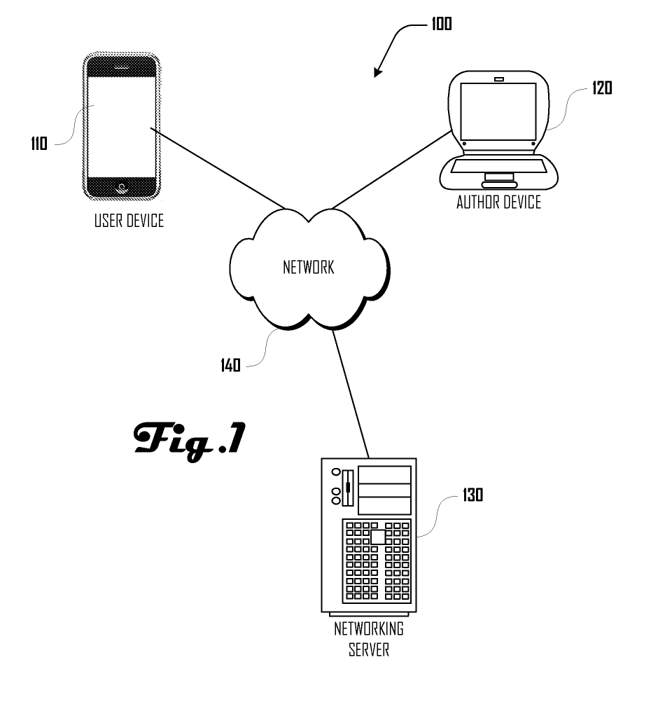

Turning to FIG. 1, the document autograph system 100 is shown as comprising a user device 110, and author device 120, and an autograph server 130 that are operably connected via a network 140. Although the user device 110 and author device 120 are depicted as being a smartphone and laptop computer respectively, in various embodiments, the user device 110 and author device may be any suitable device, including a tablet computer, gaming device, desktop computer, smartphone, laptop computer or the like. Additionally, various embodiments may include any suitable plurality of user devices 110 and author devices 120 and any suitable number of users and authors. The networking server 130 may comprise one or more server or other suitable computer system, and may include a cloud-based system, or the like. The network 140 may comprise one or more suitable wireless or wired networks including the Internet, a wide fidelity (Wi-Fi) network, a local area network (LAN), or the like.

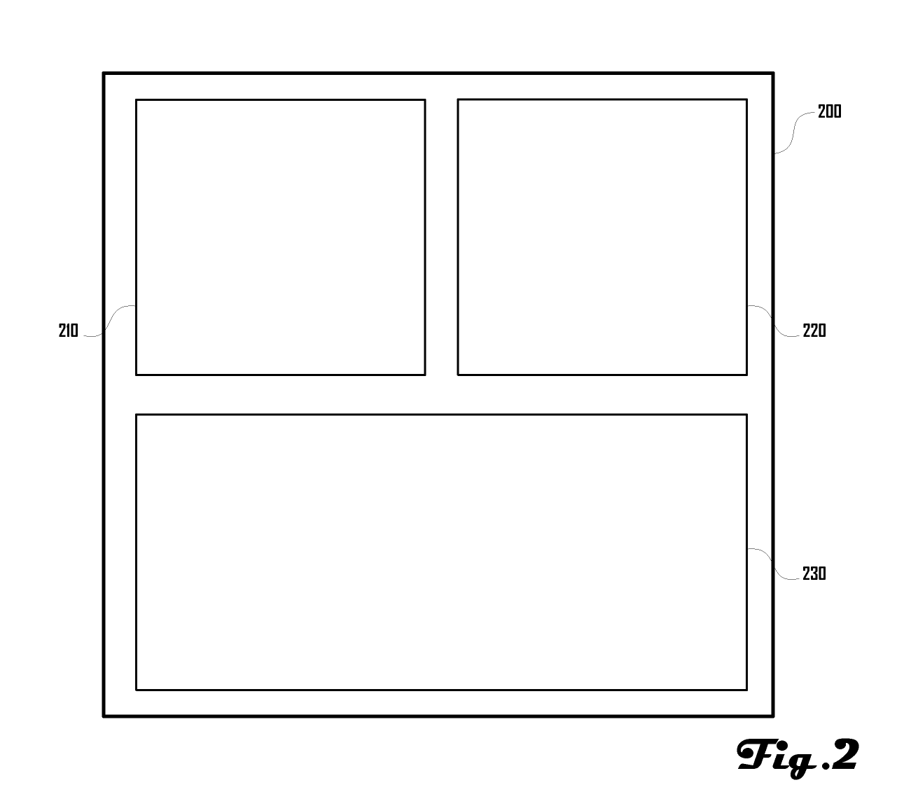

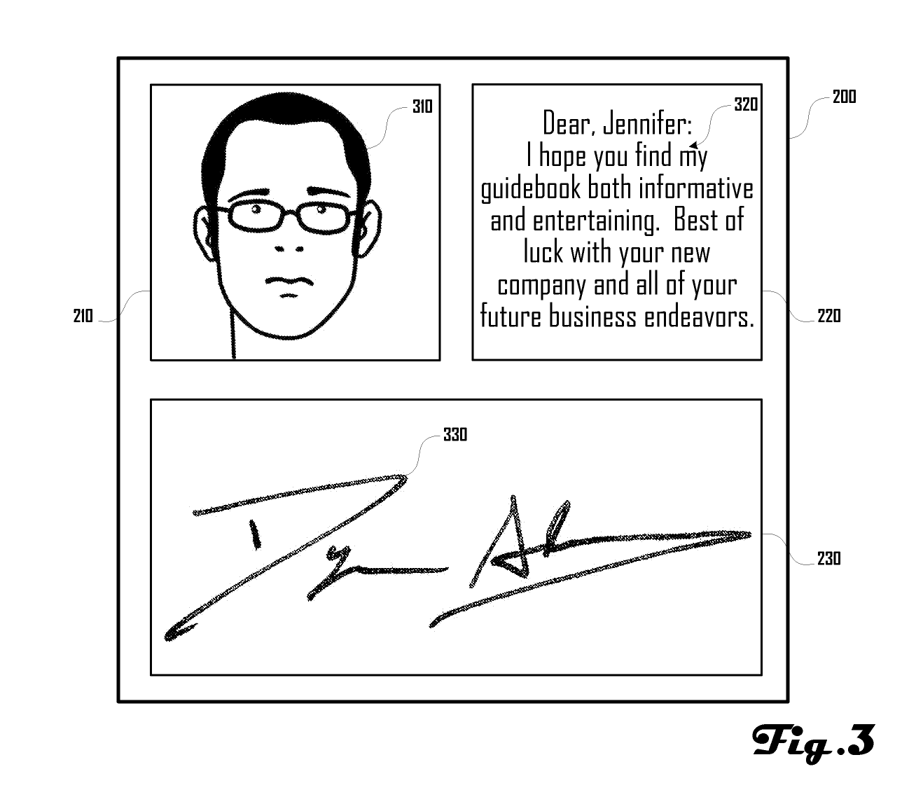

FIGS. 2 and 3 depict an author-autograph interface 200 that comprises a media field 210, a text field 220 and a signature field 230. Although a specific configuration, layout and functionality set is depicted herein, an author-autograph interface 200 can be any suitable configuration in some embodiments. For example, any of the fields 210, 220, 230 may be present in plurality, may be absent, and may be positioned in any suitable location on the interface. In some embodiments, an autograph interface may include a plurality of pages or screens. Accordingly, the present example embodiment of an author-autograph interface 200 should not be construed to be limiting.

As discussed herein, it may be desirable for authors to generate personalized autographs for electronic documents such as e-books. An author-autograph interface 200 may provide for such personalization. For example, an author may select or generate media 310 for the media field 210, which may include an image, video, or the like. In some embodiments, the author may generate an image with the author device 120 (e.g., taking a “selfie” with the author device 120), and the generated image may be presented in the media field 210. The author may also write text 320 that is presented in the text field 220 as depicted in FIG. 3. In some embodiments, the author may select predefined text for presentation in the text field 220.

The author may further generate a signature 330 that is presented in the signature field 230. For example, in some embodiments, the author device 120 comprises a touchscreen and the author can use a finger, stylus, or the like to make a signature 330. In further embodiments, any other suitable input device may be used to generate a signature 330, including a mouse, trackball, or gesture-sensing input device.

In some embodiments, the act of generating a signature 330 may be recorded and the signature 330 presented in the signature field 230 may be dynamic instead of static. For example, the drawing of the signature 330 may be played or reproduced as a video, moving graphic, or the like. In some embodiments, an author may select a previously generated static or dynamic signature. The author autograph is first drawn by the author the input device such as but not limited to an iOS device (an iPad). The view presented to the author/user is generated with a cross language, multi-platform application programming interface such as (Open Graphics Library or OpenGL) to draw and render a stroke matching the user input and mimic a signature drawn with a pen. The program can infer a thickness to the stroke of the signature, depending if the author is signing/drawing fast or slow.

The backend representation/storage structure for the signature is a list of vertexes stored as triangle, each with a timestamp. Each point is captured at a fixed rate when the user/author is drawing on the input device. Once the author/user touch the done button, this list of points is sent to the server. The server can draw the signature again and generate a video from that signature while drawing the signature on the display. The signature animation will replay and place every point, joining them at every step, thus replaying the user input exactly as it was initially drawn on the input device by the user/author. Each captured frame is assembled into a video representing the user signature. The speed of the signature in each frame depend of the number of vertexes drawn into each frame.

The system generates the signature video on the server side, so the user/author on the input device does not have to wait for a video to be generated on the client device. The system is only sends a list of points/coordinates to the server, therefore generating a very compact file size, allowing the user/author to quickly transition to the next autograph.

The server uses those points/coordinate to replay and generate a video of the signature, this video is then used for displaying on various places, including the autograph viewer on the user device application, such as iOS app, and on the website. The system is not limited to using the cross language, multi-platform application programming interface such as (Open Graphics Library or OpenGL) and our drawing algorithms in the main system application or on the website. The system presents only a single point of failure, which is the server, once the signature video is generated the signature video can be used anywhere to show the author signature exactly as the signature was initially drawn by the author on the Autograph application. The system only need to capture the author's signature once and the system can replay the signature for everyone to view.

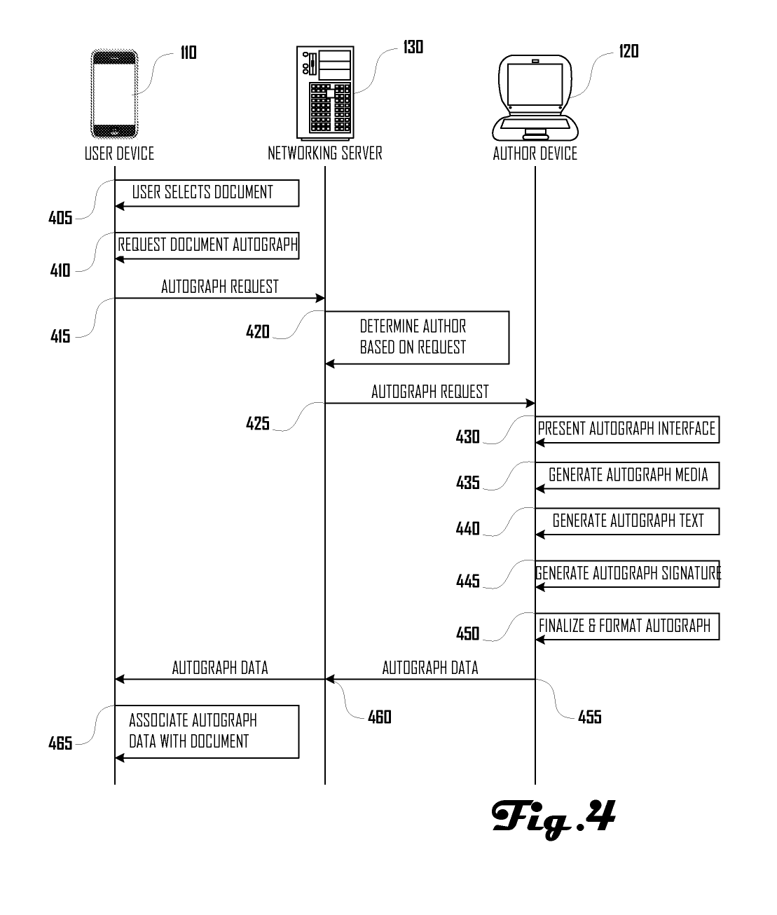

Although the location, size, shape and position of the frames 210, 220, 230 may be fixed in some embodiments, in other embodiments, the frames 210, 220, 230 may be customized in any suitable way along with other features of the interface 200. For example, the frames 210, 220, 230 may be added, removed, moved, resized, reshaped, and have modified attributes that include color, line style, line width, or the like. Elements such as a background wallpaper or color of other portions of the interface 200 may also be customized. One the autograph has been formatted and generated in a way that is suitable, the author may finalize the autograph and send it to a requesting user as further described herein as shown in FIG. 4.

Turning now to FIG. 4, a data flow is depicted that illustrates a user requesting an autograph, an author generating an autograph, and the user receiving an autograph. For example, just as with physical books, users of e-books and other media may desire to have an author (or authors) sign their e-books. The data flow of FIG. 4 begins at 405, where a user selects a document (such as an e-book) and requests an autograph for the document at 410.

In some embodiments, the user may simply click a button to request an autograph; however, in further embodiments, the content of an autograph request may comprise additional data or require further steps. For example, in some embodiments the user may provide comments, instructions or otherwise provide a note along with the request. In further embodiments, a user may select various attributes or a type of autograph that is available. In some embodiments, a user may be required to provide a payment, donation or the like, and requesting an autograph may comprise facilitating such a payment or donation.

Returning to the communications of FIG. 4, an autograph request is sent to the networking server 130, at 415, and an author is determined at 420. An autograph request is sent to the author device 120 associated with the determined author, at 425. An author may be notified of pending requests in various ways, including a mail-like interface that may be like e-mail or other messaging. Accordingly, in some embodiments, the author may view a plurality of autograph requests simultaneously and in an autograph interface 200 or the like. The author may therefore selectively fulfill autograph requests in some embodiments.

At 430, the autograph interface 200 is presented on the author device. Autograph media 310 is generated at 435, autograph text 320 is generated at 440 and an autograph signature 330 is generated at 445. The autograph is finalized and formatted at 450. Autograph data is sent to the networking server at 455 and sent to the user device at 460, where the autograph data is associated with the document, at 465.

In some embodiments, an autograph may be formatted in any suitable form, which may be simple or complex. For example, the autograph may be formatted into a single static or dynamic image or may comprise media and text formatted via a markup language such as HTML, or the like. In some embodiments, a plurality of formatted versions of the autograph may be generated.

Autographs and autograph data may be associated with a document in various ways. For example, the document may be modified to reference or call a separate file, or files, that define an autograph. However, in some embodiments the document may be modified to include the autograph or autograph data, such that the autograph or autograph data becomes part of the file that defines the document. Accordingly, autographs may or may not be easily removable or disassociated with a given document. For example, in some embodiments, autographs may become locked as a portion of the document and may be inseparable from the document or difficult to remove.

Although FIG. 4 depicts an intermediary device, such as the networking server 130, which facilitates transfer of an autograph, in some embodiments transfer of an autograph or autograph data may occur directly between the user device 110 and author device 120. For example, at a live signing event, the author may generate an autograph and send it directly to the user device 110 via near-field communication (NFC), a local wired connection such as a universal serial bus (USB) connection, via a local wireless connection such as Wi-Fi or Bluetooth, or the like.

Additionally, software for the autograph interface 200 may be present on the author device in the form of an application or the like; however, in some embodiments, the autograph interface 200 may be hosted on a remote server such as the networking server 130. For example, the autograph interface 200 may be a webpage hosted on the networking server 130 that can be accessed by the author device 120 via a web-browser, or the like.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method for generating an electronic document autograph comprising:
presenting an author-autograph interface including:
a media frame;
a text frame; and
a signature frame;
receiving media for the media frame;
presenting the received media in the media frame;
receiving a text input for the text frame;
presenting the received text in the text frame;
receiving a signature input for the signature frame; and
presenting the signature in the signature frame.

2. The method of claim 1 further comprising, receiving a finalization input and finalizing an autograph based on the presented author-autograph interface.

3. The method of claim 2, wherein finalization of the autograph comprises modifying one or more attribute of at least one of the media frame, text frame and signature frame.

4. The method of claim 3, wherein a modified attribute comprises at least one of a location, size, shape and position of one or more of the media frame, the text frame and the signature frame.

5. The method of claim 1, wherein the media comprises one of a video and image.

6. The method of claim 1, wherein the signature is presented as a dynamic moving graphic.

7. The method of claim 1, further comprising receiving an autograph request and presenting the author-autograph interface in response to the autograph request.

8. The method of claim 7, wherein the autograph request is associated with a selected document.

9. The method of claim 8, wherein the selected document is an e-book.

10. The method of claim 8, wherein finalization of the autograph comprises incorporating autograph data into a document file that defines the document.

11. A method for generating an electronic document autograph comprising:
providing an autograph device including:
a touchscreen display; and
a camera;
receiving at the autograph device an autograph request;
presenting on the touchscreen an author-autograph interface in response to the autograph request including:
a media frame;
a text frame; and
a signature frame;
receiving media for the media frame;
presenting the received media in the media frame;
receiving a text input for the text frame;
presenting the received text in the text frame;
receiving a signature input for the signature frame; and
presenting the signature in the signature frame.

12. The method of claim 11, wherein receiving media for the media frame comprises generating one of an image and video via the camera.

13. The method of claim 11, wherein receiving text input for the text frame comprises receiving touch input via the touchscreen.

14. The method of claim 13, wherein receiving text input comprises receiving writing input via at least one of a finger and stylus interacting with the touchscreen.

15. The method of claim 11, wherein receiving the signature input comprises receiving signature input via at least one of a finger and stylus interacting with the touchscreen.

16. The method of claim 15, wherein the signature is presented as a dynamic moving graphic corresponding to the signature input received via at least one of a finger and stylus interacting with the touchscreen.

17. The method of claim 11 further comprising, receiving a finalization input and finalizing an autograph based on the presented author-autograph interface, and wherein the finalized autograph is sent to a device that sent the autograph request.
